(19) United States
(12) Patent Application Publication
(10) Pub. No.: US 2012/0076696 A1
(43) Pub. Date: Mar. 29, 2012

(54) Apparatus for hydrogenation and method for hydrogenating conjugated diene polymer by employing the apparatus

(75) Inventors: Chen-Pao Huang, Taichung (TW); Kuei-Lun Chen, Tainan (TW)

(73) Assignee: CHI-MEI CORPORATION

(21) Appl. No.: 13/317,241

(22) Filed: Oct. 13, 2011

Related U.S. Application Data
(63) Continuation-in-part of application No. 12/081,603, filed on Apr. 17, 2008, now abandoned.

(51) Int. Cl. B01J 19/18

(52) U.S. Cl. 422/134; 422/131; 422/135

(57) ABSTRACT

The present invention provides an apparatus and a method for continuous hydrogenation of conjugated diene polymer. By feeding the conjugated diene polymer, a catalyst composition and a hydrogen to the apparatus for hydrogenation. This apparatus for hydrogenation includes at least one hydrogenation reaction unit each comprising at least one a hydrogenation reactor with an outlet and at least one heat exchanger. In the hydrogenation reaction unit, the conjugated diene polymer, the catalyst composition and the hydrogen are mixed in a non-mechanical mixing mode and proceed hydrogenation with heat exchanger being connected to the outlet of the hydrogenation reactor.

This is a Continuation-in-Part application Ser. No. 12/081,603 filed on Apr. 17, 2008.

### BACKGROUND OF THE INVENTION

1. Field of the Invention

The present invention relates to an apparatus for hydrogenation of a conjugated diene polymer and a method for hydrogenation by employing the apparatus, and more particularly to an apparatus and a method for continuously hydrogenating conjugated diene polymers.

2. Description of the Prior Arts

For industrial application and commercial production, the utilization of conjugated dienes (e.g. butadiene, isoprene) in polymerization or copolymerization reactions for preparing synthetic rubbers has been widely used. However, these unsaturated double bonds of synthetic rubbers are vulnerable toward oxidation and lack of thermal stability at elevated temperature or weathering (exposure to ozone).

This deficiency in thermal and weathering stability can be improved by reducing the content of the unsaturated double bonds contained in the polymer chain through hydrogenation. Technically, bis(cyclopentadienyl)titanium compound as a homogeneous catalyst for hydrogenating the conjugated diene polymer is an effective method. In U.S. Pat. No. 6,313,230 discloses a catalyst composition for hydrogenating the conjugated diene polymer, which primarily includes at least a bis(cyclopentadienyl)titanium, a siloxane compound and a metallic compound. Additionally, in U.S. Pat. No. 6,881,797 also discloses a catalyst composition for hydrogenating the conjugated diene polymer, which composition primarily included a bis(cyclopentadienyl)titanium, a trialkyl aluminum and a compound of formula (I):

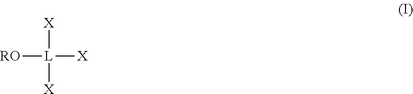

Wherein L is an element of the IVB family, R is an alkyl or cycloalkyl group of C₁˜C₁₂, X can be the same or different and is an alkyl, alkoxy or cycloalkoxy group of C₁˜C₁₂, a halogen atom or a carbonyl group.

However, during hydrogenation of the unsaturated double bonds of conjugated diene polymer by the abovementioned catalyst composition, the temperature of hydrogenation will raise sharply after a period time of hydrogenation due to the acceleration of the exothermic reaction of hydrogenation. As a result, hydrogenation conversion of the polymer is decreased since the catalyst composition becomes inactive at such a high temperature. That is, though the above catalyst composition may enhance the rate of hydrogenation, which results in a higher reaction temperature that shortens the life of the catalyst composition. Therefore, it's necessary to provide an apparatus and a method for hydrogenating the conjugated diene polymer, which can promote the hydrogenation conversion without reducing life of the catalyst composition.

### SUMMARY OF THE INVENTION

In order to overcome the disadvantage of inactivation of the catalyst composition resulted from the high temperature of the exothermic reaction during hydrogenation of the conjugated diene polymer, the present invention provides a combination of at least one hydrogenation reactor and at least one heat exchanger for hydrogenating the conjugated diene polymer with proper operation conditions, for example, temperature, pressure of hydrogenation, etc. Accordingly, life of the catalyst composition will be prolonged and the hydrogenation conversion will be promoted.

Therefore, the first object of the present invention is to provide an apparatus for continuous hydrogenation of a conjugated diene polymer, comprising at least one hydrogenation reaction unit, wherein each of the hydrogenation reaction unit comprising at least one hydrogenation reactor which has an outlet, and wherein the conjugated diene polymer, a catalyst and a hydrogen are mixed in the hydrogenation reactor by a non-mechanical mixing mode and proceed hydrogenation reaction; and at least one heat exchanger being connected to the outlet of at least one of the hydrogenation reactor. Said apparatus is good for high hydrogenation conversion by continuous process.

The second object of the present invention is to provide a method for continuous hydrogenation of a conjugated diene polymer by employing the apparatus, which includes steps of:

(a) providing the above mentioned apparatus for hydrogenation,

(b) feeding a conjugated diene polymer, a catalyst composition and a hydrogen into the hydrogenation reactor of the hydrogenation reaction unit of the step (a), and mixing them in a non-mechanical mixing mode for hydrogenation to obtain a hydrogenated mixture; and

(c) introducing the hydrogenated mixture into the heat exchanger to remove heat and obtain a hydrogenated conjugated diene polymer with a high hydrogenation conversion. For a continuous hydrogenation process, the conjugated diene polymer is continuously fed into the hydrogenation reactor, and the catalyst composition and the hydrogen can be fed into the reactor continuously.

In the present invention, the number of units the hydrogenation reaction unit may be one or more, and preferably two or more. Each hydrogenation reaction unit comprising at least one hydrogenation reactor and one heat exchanger. Two or more hydrogenation reaction units can be arranged in series or parallel, or a combination of series/parallel. When the hydrogenation reaction units are arranged in parallel, the conjugated diene polymer, the catalyst composition and the hydrogen are fed into the parallel hydrogenation reactors, respectively. When the hydrogenation reaction units are arranged in series, the conjugated diene polymer, the catalyst composition and the hydrogen are preferably fed into the hydrogenation reactor of the upstream (initial) hydrogenation reaction unit. Optionally, further hydrogen or the catalyst composition can be fed into the second or afterward reactors. The hydrogenated mixture from the initial hydrogenation reactor is introduced into the heat exchanger of the initial hydrogenation reaction unit through the outlet to remove heat. Then, the hydrogenated mixture (includes a partial hydrogenated conjugated diene polymer, a catalyst composition and a hydrogen) is further introduced into a downstream hydrogenation reaction unit in a sequence of a hydrogenation reactor followed by a heat exchanger, whereby hydrogenation and heat removal are carried out. In the case of hydrogenation reaction units arranged in series, the last (downstream) hydrogenation reaction unit includes at least one hydrogenation reactor and at least one heat exchanger, for example, a hydrogenation reactor and a heat exchanger. After the last hydrogenation reaction unit, a collecting unit is connected thereto. For example, the hydrogenation reaction unit can be composed of two hydrogenation reactors and a heat exchanger, which can be arranged in series as a hydrogenation reactor→a heat exchanger→a hydrogenation reactor, and then connected to a collecting unit.

In the present invention, the hydrogenation reactor is preferably installed vertically relative to the ground, so that the conjugated diene polymer can be fed into the hydrogenation reactor and flow downward by gravity.

In the present invention, the hydrogenation reactor defines a chamber, for example, a column, and at least one packing deposited in the chamber. The packing is used to buffer the downward velocity of the conjugated diene polymer solution and distributes the polymer solution, so that the polymer, the catalyst composition and the hydrogen may contact with each other and the hydrogenation conversion is promoted. The reaction may contain a set or many sets of the packing and packing sets can be placed in any feasible arrangement, for example, in series or parallel or both. Each packing includes at least one plate which can be in any proper shape. For the purpose of mixing the polymer with the hydrogen and the catalyst composition, the plate is preferably corrugated with tilted chutes formed between adjacent two peaks of the corrugated plate, so that the reaction mixture can flow down along the chutes. Alignments of the chutes are crossed for every two adjacent plates, that is, the alignment of one corrugated plate is crossed with the alignment of adjacent corrugated plate. The chutes are slanted and have a tilt angle ranging between 15 degrees and 65 degrees relative to their projection lines on the horizon. Beyond such range, the hydrogenation result of the polymer will worsen. In addition, at least one hole penetrating the plate is formed on a wall of the chute. The plates of the packing in the present invention are arranged parallel to each other, and the adjacent plates are closed to or contact with each other. The angle between the plate and the horizon is 0°˜90°, preferably 45°˜90°, more preferably 60°˜90°.

In the present invention, the hydrogenation reactor can include a heat exchange jacket surrounding the chamber for exchange of heat (removing or supplying). In the heat exchange jacket, a cooling media, such as water and coolant, or a heating media can flow through at a temperature ranging between 0° C. and 200° C., preferably between 20° C. and 150° C., and more preferably between 30° C. and 100° C. The hydrogenation reactor includes at least one feeding inlet for feeding the polymer, and can further include a distributing element adjacent to the feeding inlet so as to distribute the polymer and the catalyst composition, etc. The distributing element can be any proper type which can uniformly distribute the conjugated diene polymer and the catalyst composition so as to well contact with the hydrogen. Such as a sieve distributor. The hydrogenation reactor has a gas inlet for the hydrogen feed. The hydrogen can be introduced at an upper, middle or lower part of the hydrogenation reactor. The apparatus for hydrogenation may have one or more gas inlets. For example, an apparatus for hydrogenation with six hydrogenation reactors can has the gas inlet(s) at the first (upstream), the first and the third, the first, the third and the fifth, the third and the fifth, or the first and the second hydrogenation reactors. The hydrogen can be fed and flow in the same or counter direction to the polymer.

In the present invention, the hydrogenation reactor is provided for mixing the conjugated diene polymer, the catalyst composition and the hydrogen by a non-mechanical mixing mode to hydrogenate the polymer. In the present invention, “non-mechanical mixing” means that mixing is completed without a mechanical means, such as a stirrer. The preferred examples of non-mechanical mixing of the present invention are a packing bed filled with a saddle-shaped packing, a trickled bed and a static mixer.

In the present invention, the heat exchanger for removing heat generated during hydrogenation can be any proper types, for example, the conventional heat exchanger including the shell and tube heat exchanger, plate heat exchanger, etc. The heat exchanger is connected to the outlet of the hydrogenation reactor. Between the heat exchanger and the hydrogenation reactor, a guiding part may be used for connection so as to introduce the hydrogenated mixture into the heat exchanger from the outlet of the hydrogenation reactor. A part of the hydrogenated mixture flowing out from the heat exchanger can be reflux to the hydrogenation reactor of the same or former (upstream) hydrogenation reaction unit, and the other is introduced into the latter (downstream) hydrogenation reaction unit or the collecting unit.

In the present invention, the apparatus for continuous hydrogenation can further comprises a mixing unit prior to and connected to the hydrogenation reaction unit. The mixing unit includes a mixing tank for contacting the conjugated diene polymer with the catalyst composition. Alternatively, the conjugated diene polymer can be previously polymerized and then introduced to the apparatus for hydrogenation of the present invention, and then obtain the hydrogenated conjugated diene polymer by the continuous hydrogenation process of the present invention. In addition, the hydrogen can be introduced to premix with the conjugated diene polymer and the catalyst composition in the mixing tank.

In the present invention, the apparatus for continuous hydrogenation can further comprise a collecting unit connected to the outlet of the last hydrogenation reactor so that the hydrogenated conjugated diene polymer can be collected in the collecting unit via the outlet. The collecting unit can be any proper vessel suitable for collecting the product, for example, a storage tank.

In the present invention, the method for continuous hydrogenation of a conjugated diene polymer comprises steps of: (a) providing the above-mentioned apparatus for hydrogenation which comprises at least one hydrogenation reaction unit each comprising at least one hydrogenation reactor with an outlet, and a heat exchanger connected to the outlet of the hydrogenation reactor; (b) feeding the conjugated diene polymer, a catalyst composition and a hydrogen into the hydrogenation reactor, and mixing them in a non-mechanical mixing mode and hydrogenating to obtain a hydrogenated mixture; (c) introducing the hydrogenated mixture into the heat exchanger through the outlet of the hydrogenation reactor so as to remove heat and obtain a hydrogenated conjugated diene polymer with high hydrogenation conversion.

In the method of the present invention, the hydrogenation reactor of the step (a) has an average temperature (feeding zone temperature+outlet zone temperature)/2) ranging between 20° C. and 200° C., preferably between 30° C. and 150° C., and a pressure ranging between 0.1 kg/cm² and 100 kg/cm², preferably between 1 kg/cm² and 30 kg/cm². In practical application, the average temperature of the hydrogenation reactor depends on the desired hydrogenation conversion, types of the polymer and the catalyst composition.

In the method of the present invention, the conjugated diene polymer and the catalyst composition of the step (b) can be previously mixed in the mixing unit and then introduced into the hydrogenation reactor to mix with the hydrogen.

In the present invention, the conjugated diene polymer comprises homopolymers or copolymers, for example, the homopolymers of conjugated dienes, the copolymers of different conjugated dienes, and copolymers of at least a conjugated diene and at least an olefin monomer. The conjugated dienes used in the production of these conjugated diene polymers are generally those having 4 to 12 carbon atoms. Specific examples thereof are 1,3-butadiene, isoprene, 2,3-dimethyl-1,3-butadiene, 1,3-pentadiene, 2-methyl-1,3-pentadiene, 1,3-hexadiene and 4,5-diethyl-1,3-butadiene, wherein 1,3-butadiene and isoprene are particularly preferred. Examples of the olefin monomer for copolymerizing with the conjugated diene include styrene, t-butyl styrene, α-methyl styrene, p-methyl styrene, divinylbenzene, 1,1-diphenylethylene, N,N-dimethyl-p-aminoethyls, N,N-diethyl-p-aminoethylstyrene, etc, wherein styrene is particularly preferred. Examples of the copolymers of a conjugated diene and a vinyl aromatic hydrocarbon include a butadiene/styrene copolymer and an isoprene/styrene copolymer, and these two copolymers are the most preferable because they provide hydrogenated copolymers of high industrial value. The above conjugated diene polymer may include a random structure, a tapered structure, a block structure, or a grafted structure. The block copolymers may be a linear type, a branch type, a radial type and a star type. The conjugated diene polymer suitable for hydrogenation with the catalyst of the present invention has a number average molecular weight ranging between 500 and 1,000,000, preferably 1,000˜750,000, and more preferably 10,000˜500,000.

Example of the conjugated diene polymer suitable for the present invention can be is linear styrene-butadiene-styrene (SBS) block copolymers, in which content of styrene ranges between 5 wt. % and 95 wt. % and content of vinyl structure ranges between 5 wt. % and 75 wt. %. The conjugated diene polymer has a number average molecular weight ranging between 500 and 1,000,000, preferably between 1,000 and 750,000, and more preferably between 10,000 and 500,000.

A conjugated diene polymer solution can be previously prepared by polymerizing a conjugated diene monomer and an olefin monomer in a proper solvent by anionic polymerization process. The conjugated diene polymer solution can be directly fed into the apparatus for hydrogenation of the present invention. In the present invention, another preferred method is to mix a devolatilized conjugated diene polymer in a solid state with a proper solvent to form a solution the conjugated diene polymer solution which is then fed into the apparatus for hydrogenation of the present invention. The solid content of the conjugated diene polymer solution is not particularly restricted, generally 5%˜40%, preferably 8%˜30%, and more preferably 10%˜25%. The solvent is not particularly restricted either, and can be any one suitable for dissolving the conjugated diene polymer. Preferably an inert solvent, i.e., a solvent not reacting with the hydrogen or not participating in the hydrogenation, for example, cyclohexane, n-hexane, benzene, ethylbenzene, toluene, etc can be used.

In the present invention, the conjugated diene polymer is hydrogenated in the hydrogenation reactor to obtain a hydrogenated mixture which comprises a catalyst composition, a hydrogen and partially hydrogenated conjugated diene polymer.

In the present invention, the catalyst composition includes a cyclopentadienyl titanium compound and a silyl hydride, for example, bis(cyclopentadienyl)titanium dichloride (Cp₂TiCl₂) and polymethylhydrosiloxane.

The catalyst composition includes a cyclopentadienyl titanium compound and/or a silyl hydride, and/or a compound (A) having a structural formula (a):

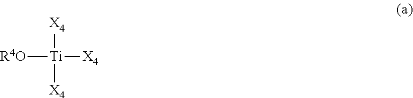

wherein R⁴ is an alkyl group of C₁˜C₁₂ or a cycloalkyl group of C₁˜C₁₂, X₄ can be the same or different and is an alkyl group of C₁˜C₁₂, an alkoxy group of C₁˜C₁₂, cycloalkoxy group of C₁˜C₁₂, a halogen atom or a carbonyl group.

Examples of the cyclopentadienyl titanium compound includes bis(cyclopentadienyl)titanium dichloride, bis(cyclopentadienyl)titanium dibromide, bis(cyclopentadienyl)titanium duiodide, bis(cyclopentadienyl)titanium difluoride, bis(cyclopentadienyl)titanium dicarbonyl, bis(cyclopentadienyl)titanium dimethyl, bis(cyclopentadienyl)titanium diethyl, bis(cyclopentadienyl)titanium dipropyl (including isopropyl), bis(cyclopentadienyl)titanium dibutyl (including n-butyl, sec-butyl, tert-butyl), bis(cyclopentadienyl)titanium dibenzyl, bis(cyclopentadienyl)titanium diphenyl, bis(cyclopentadienyl)titanium dimethoxide, bis(cyclopentadienyl)titanium diethoxide, bis(cyclopentadienyl)titanium dipropoxide, bis(cyclopentadienyl)titanium dibutoxide, bis(cyclopentadienyl)titanium diphenoxide, bis(cyclopentadienyl)titanium methyl chloride, bis(cyclopentadienyl)titanium methyl bromide, bis(cyclopentadienyl)titanium methyl iodide, bis(cyclopentadienyl)titanium methyl fluoride, bis(pentamethylcyclopentadienyl)titanium dichloride, bis(pentamethylcyclopentadienyl)titanium dibromide, bis(pentamethylcyclopentadienyl)titanium diiodide, bis(pentamethyl cyclopentadienyl)titanium difluoride, bis(pentamethylcyclopentadienyl)titanium dicarbonyl, bis(pentamethylcyclopentadienyl)titanium dibutyl (including n-butyl, sec-butyl, tert-butyl), bis(pentamethylcyclopentadienyl)titanium dibenzyl, bis(pentamethylcyclopentadienyl)titanium diphenyl, and a mixture thereof.

In the present invention, the silyl hydride includes (i) a monomeric silyl hydride, (ii) a polymeric silyl hydride, and (iii) a cyclic silyl hydride.

Preferred examples of the monomeric silyl hydride include methyl dichlorosilane, ethyl dichlorosilane, propyl dichlorosilane, butyl dichlorosilane, phenyl dichlorosilane, dimethyl chlorosilane, diethyl chlorosilane, dipropyl chlorosilane, dibutyl chlorosilane, diphenyl chlorosilane, dimethyl methoxy silane, dimethyl ethoxy silane, dimethyl propoxy silane, dimethyl butoxy silane, dimethyl benzoxy silane, diethyl ethoxy silane, diethyl ethoxy silane, diethyl propoxy silane, diethyl butoxy silane, diethyl benzoxy silane, dipropyl methoxy silane, dipropyl ethoxy silane, dipropyl propoxy silane, dipropyl butoxy silane, dipropyl benzoxy silane, dibutyl methoxy silane, dibutyl ethoxy silane, dibutyl propoxy silane, dibutyl butoxy silane, dibutyl benzoxy silane, diphenyl methoxy silane, diphenyl ethoxy silane, diphenyl propoxy silane, diphenyl butoxy silane, diphenyl benzoxy silane, dimethylsilane, diethylsilane, dipropyl silane, dibutylsilane, diphyenylsilane, diphenylmethylsilane, diphenylethylsilane, diphenylpropylsilane, diphenylbutylsilane, trimethylsilane, triethylsilane, tripropylsilane, tributylsilane, triphenylsilane, methylsilane, ethylsilane, propylsilane, butylsilane, phenylsilane and methyldiacetoxysilane.

Preferred examples of the polymeric silyl hydride include polymethylhydrosiloxane, polyethylhydrosiloxane, polypropylhydrosiloxane, polybutylhydrosiloxane, polyphenylhydrosiloxane and 1,1,3,3-tetramethyldisiloxane.

Preferably, examples of the cyclic silyl hydride include methylhydro cyclosiloxane, ethyllhydrocyclosiloxane, propylhydrocyclosiloxane, butylhydro-cyclosiloxane, and phenylhydrocyclosiloxane.

Examples of the compound (A) having a formula (a) include titanium(IV)ethoxide, titanium(IV)n-propoxide, titanium(IV)isopropoxide (TPT), titanium(IV)n-butoxide (TnBT), titanium(IV)sec-butoxide, titanium(IV)isobutoxide, titanium(IV)n-pentoxide, titanium(IV)isopentoxide, titanium(IV)1-methylbutoxide, titanium(IV)2-methylbutoxide, titanium(IV)1,2-dimethylbutoxide, titanium(IV)neopentoxide, titanium(IV)n-hexoxide, titanium(IV)iso-hexoxide, titanium(IV)1,1-dimethyl butoxide, titanium(IV)2,2-dimethylbutoxide, titanium(IV)3,3-dimethylbutoxide, titanium(IV)n-dodecoxide, etc.

The catalyst composition of the present invention can further include other components, for example, titanium(IV)ethoxide, titanium(IV)n-propoxide, titanium(IV)isopropoxide (TPT), titanium(IV)n-butoxide (TnBT), titanium(IV)sec-butoxide, titanium(IV)isobutoxide, titanium(IV)n-pentoxide, titanium(IV)isopentoxide, titanium(IV)1-methylbutoxide, titanium(IV)2-methylbutoxide, titanium(IV)1,2-dimethylbutoxide, titanium(IV)neopentoxide, titanium(IV)n-hexoxide, titanium(IV)isohexoxide, titanium(IV)1,1-dimethylbutoxide, titanium(IV)2,2-dimethylbutoxide, titanium(IV)3,3-dimethylbutoxide, titanium(IV)n-dodecoxide, etc. More other components suitable for adding into the catalyst composition can be metal compounds, for example, an organic lithium compound, an organic aluminum compound, an organic magnesium compound, an organic zinc compound, a LiH or LiOR′ compound (R′=alkyl, aryl, aralkyl or cycloalkyl). Examples of the above organic lithium compound include: n-propyl lithium, iso-propyl lithium, n-butyl lithium (NBL), sec-butyl lithium, tert-butyl lithium, n-pentyl lithium, a dilithium compound, and an anionic active polymer having active lithium thereon. Examples of the above organic aluminum compound include trimethyl aluminum, triethyl aluminum, triisobutyl aluminum, triphenyl aluminum, diethyl aluminum chloride, methyl aluminium sesquichloride, ethyl aluminum sesquichloride, diethyl aluminium hydride, diisobutyl aluminium hydride, triphenyl aluminum, and tri(2-ethylhexyl)aluminum, etc. Examples of the above organic magnesium compound include dimethyl magnesium, diethyl magnesium, methyl magnesium bromide, methyl magnesium chloride, ethyl magnesium bromide, ethyl magnesium chloride, phenyl magnesium bromide, phenyl magnesium chloride, and. Examples of the above organic zinc compound include diethyl zinc, bis(cyclopentadienyl)zinc, and diphenyl zinc. Examples of the above LiOR′ compound include lithium methoxide, lithium ethoxide, lithium n-propoxide, lithium isopropoxide, lithium n-butoxide, lithium sec-butoxide, lithium tert-butoxide, lithium pentoxide, lithium hexoxide, lithium heptoxide, lithium octoxide, lithium phenoxide, 4-methyl phenoxide lithium, and 2,6-di-t-butyl-4-methyl phenoxide lithium.

For hydrogenation of the present invention, content of cyclopentadienyl titanium in the catalyst composition is 0.0002˜20 mmol per 100 gram of the polymer.

In the present invention, the apparatus for continuous hydrogenation of a conjugated diene polymer comprises a hydrogenation reaction unit having a hydrogenation reactor and a heat exchanger for removing heat generated during hydrogenation. Accordingly, temperature of the hydrogenation can be controlled in a proper range to achieve a high hydrogenation conversion of the hydrogenated conjugated diene polymer and thus to prolong life time of the catalyst. On the other hand, by the method of the present invention, a hydrogenated conjugated diene polymer with higher hydrogenation conversion can be obtained.

### BRIEF DESCRIPTION OF THE DRAWINGS

FIG. 1 is the first embodiment of the apparatus for hydrogenation according to the present invention;

FIG. 2 is the hydrogenation reaction unit of the first embodiment of the present invention;

FIG. 3 is the packing in the hydrogenation reaction unit of the present invention;

FIG. 4 is the enlarged figure of a part of the FIG. 3, showing the stacking of the corrugated plates;

FIG. 5 is the plates of the packing of the present invention;

FIG. 6 is a perspective view to show the corrugated plates contact with each other of the present invention;

FIG. 7 is a front view of the corrugated plate to show the relationship between the chutes and the horizon;

FIG. 8 is a front view of the other corrugated plate to show the relationship between the chutes of the corrugated plates and the horizon; and

FIG. 9 is the second embodiment of the apparatus for hydrogenation according to the present invention.

### DETAILED DESCRIPTION OF THE PREFERRED EMBODIMENTS

The present invention provides an apparatus and a method for continuous hydrogenation of the conjugated diene polymer to overcome defect of the traditional hydrogenation processes in which a high hydrogenation temperature will deactivate the catalyst composition.

More features of the apparatus and the method for continuous hydrogenation of the conjugated diene polymer will be described in the first and second embodiments accompanied with figures. It should be noticed that the similar elements are given the same number in figures.

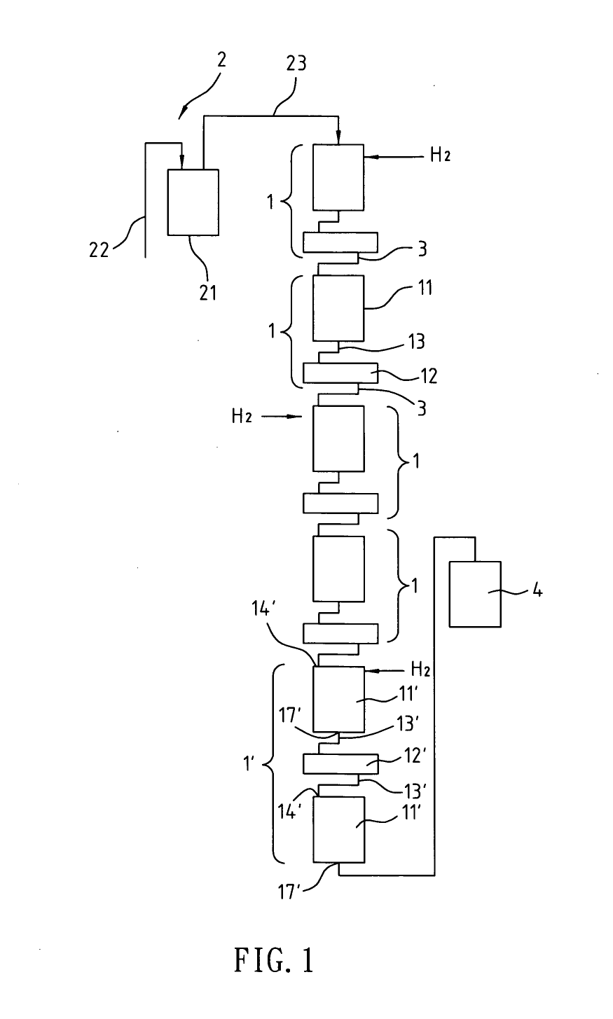

In the present invention, the apparatus for continuous hydrogenation of the conjugated diene polymer is provided for hydrogenation of a conjugated diene polymer with a catalyst composition and hydrogen. As shown in FIG. 1, the first embodiment of the apparatus for hydrogenation comprises five hydrogenation reaction units 1, 1′ (wherein 1′ is the last hydrogenation reaction unit), and a mixing unit 2 connected to the first hydrogenation reaction unit 1.

The mixing unit 2 comprises a mixing tank 21 for contacting the conjugated diene polymer with the catalyst composition, and a second pipe 23 connected to the first hydrogenation reaction unit 1. The conjugated diene polymer is fed into the mixing tank 21 through the first pipe 22 to mix with the catalyst composition which is fed individually (not shown), and then introduced into the hydrogenation reaction unit 1 through the pipe 23 to contact with the hydrogen for hydrogenation.

In this embodiment, the last hydrogenation reaction unit 1′ includes two hydrogenation reactors 11′, and each of the four other hydrogenation reaction units 1 comprises only one hydrogenation reactor 11. Each of first four the hydrogenation reaction units includes one heat exchanger 12 and one first guiding part 13 for connecting outlet of the hydrogenation reactor 11 and the heat exchanger 12. In the hydrogenation reactors 11, 11′, the conjugated diene polymer, the catalyst composition and the hydrogen are mixed in a non-mechanical mixing mode to proceed hydrogenation. In this embodiment, the hydrogen can be introduced to the first (upstream), the third and the fifth hydrogenation reactors.

The apparatus for continuous hydrogenation of the conjugated diene polymer further includes four second guiding parts 3 connected to the first four hydrogenation reaction units 1. Though the hydrogenation reaction units 1, 1′ are arranged in series in this embodiment, arrangement in parallel is possible in practice.

In this embodiment, the last hydrogenation reaction unit 1′ further includes two feeding inlets 14′ and two outlets 17′ respectively on the hydrogenation reactor 11′, and two first guiding parts 13′ for connecting the hydrogenation reactor 11′ and the heat exchanger 12′, wherein the heat exchanger 12′ is placed between two hydrogenation reactors.

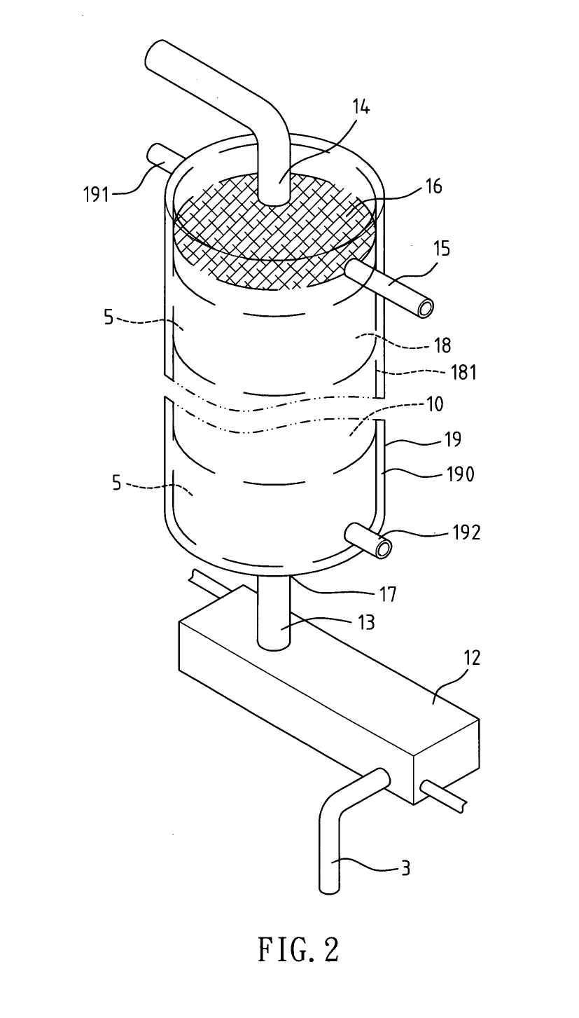

As shown in FIG. 2, the hydrogenation reactor 11 has a feeding inlet 14, a gas inlet 15, a distributing element 16 adjacent to and below the feeding hole, and an outlet 17, wherein the heat exchanger 12 has a front end connected to the outlet 17. The distributing element 16 is used to uniformly distribute the conjugated diene polymer and the catalyst, and mix them. The hydrogen can be introduced through the gas inlet 15 on the hydrogenation reactor 11.

In the distributing element 16, the conjugated diene polymer, the catalyst composition and the hydrogen can be uniformly distributed to facilitate mixing, and the distributing element is a sieve distributor.

The apparatus for continuous hydrogenation of the conjugated diene polymer further includes a collecting unit 4 connected to the outlet 17′ of the last hydrogenation reactor 11′, so that the hydrogenated conjugated diene polymer can be delivered into the collecting unit 4 through the outlet 17′.

The hydrogenation reactor 11, 11′ defines a chamber 10 and a column 18 surrounding the chamber 10, a plurality of packings 5 deposited in the chamber 10, and a jacket 19 surrounding on an outer wall 181 of the column 18. The plurality of packings 5 are used to buffer flowing velocity of the conjugated diene polymer or distribute the conjugated diene polymer, and are arranged in series.

Within the jacket 19, a space 190 is formed outside the outer wall 181 of the column 18 so that water, coolant or heat media can flow through. On each jacket 19, an inlet pipe 191 is set for introducing water, coolant or heating media into the space 190, and an outlet pipe 192 for releasing water, coolant or heat media out of the space 190. Accordingly, heat is transferred between water, coolant or heat media and the hydrogenated mixture in the chamber 10 through the outer wall 181. That is, heat can be supplemented to or removed from the hydrogenation reactor. In the embodiments of the present invention, temperature of water, coolant or heat media preferably ranges between 30° C. and 100° C.

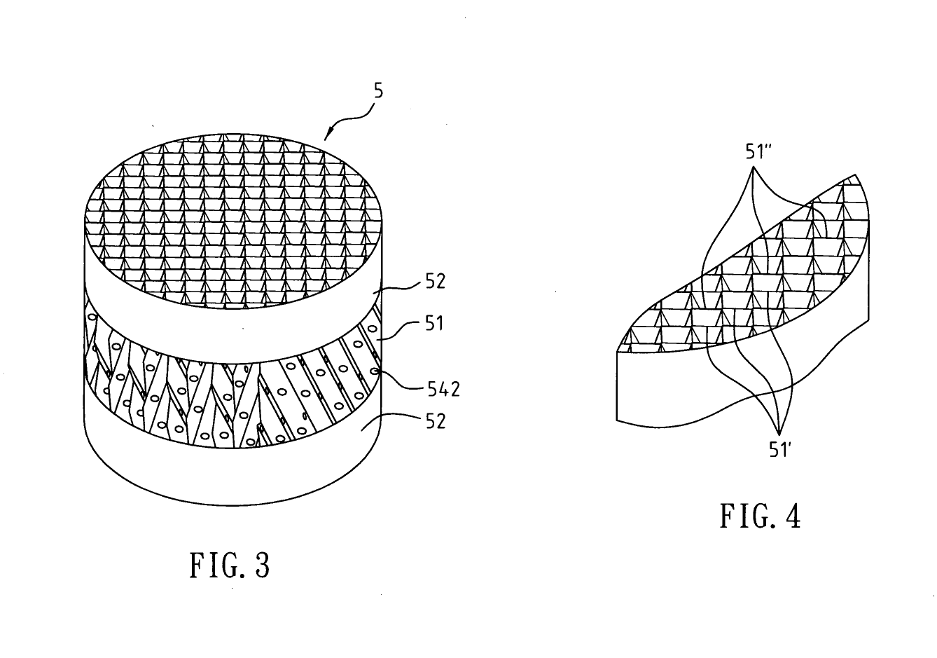

As shown in FIG. 3 of the first embodiment, each packing 5 includes a plurality of corrugated plates 51, and two tapes 52 for binding the plates as a cylinder. For some other examples the tape 52 can be one or more. The corrugated plates 51 are parallel to each other, and the adjacent plates contact with each other. The angle between the corrugated plate 51 and the horizon is 90°, that is, the horizon is a plane perpendicular to the corrugated plate. FIG. 4 is an enlarged diagram of a part of FIG. 3, which shows the first corrugated plate 51′ and the adjacent second corrugated plate 51″.

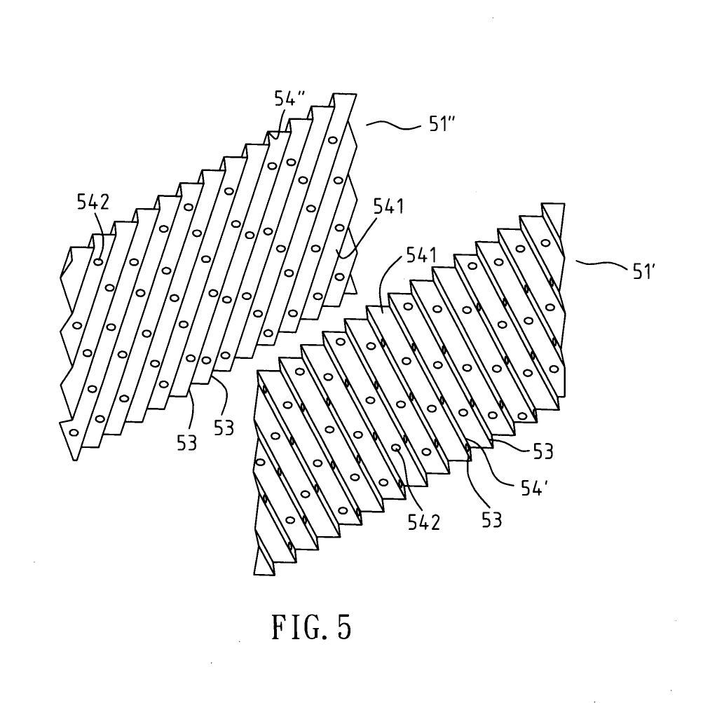

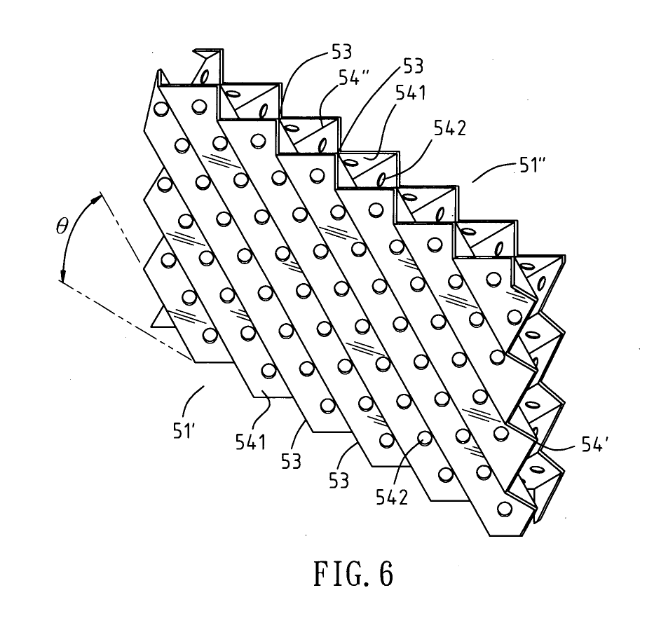

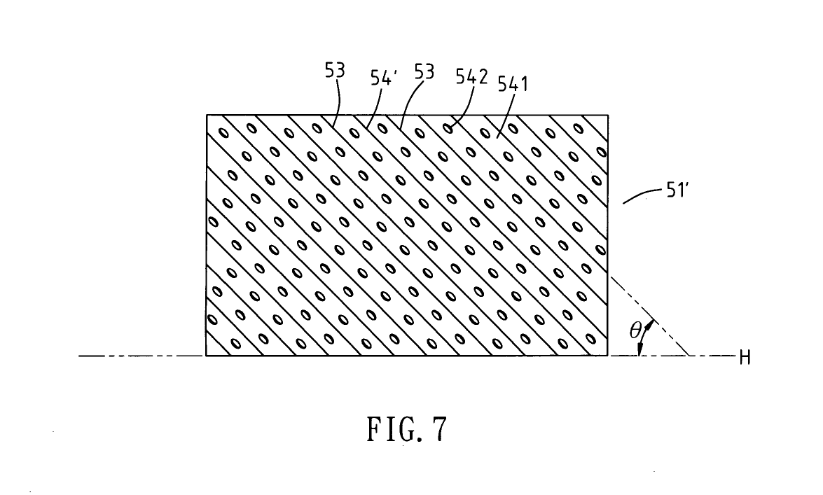

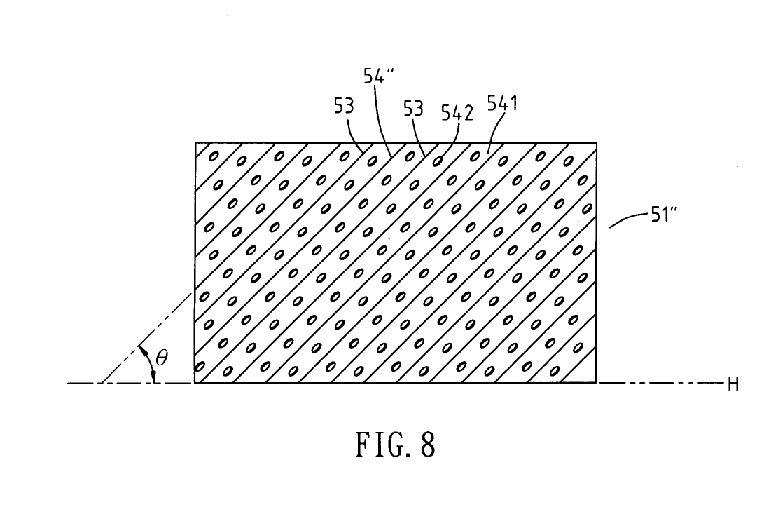

FIGS. 5 and 6 shows the detail structure of the first corrugated plate 51′ and second corrugated plate 51″. For each plate 51′, 51″, chutes 54′, 54″ are formed between two adjacent peaks 53. The alignments of the chutes 54′, 54″ on the two adjacent corrugated plates 51′, 51″ are crossed. The chutes 54′, 54″ have wall 541 with a plurality of holes 542 penetrating through the corrugated plates 51′, 51″, so that the polymer can be uniformly distributed. As shown in FIGS. 7 and 8, H is the horizon, the horizon is a plane perpendicular to the direction of gravity shown by a plumbline at the point of observation. An angle θ between the chutes 54′, 54″ and the horizon is between 15° to 65°, preferably 35° to 55°. The angle θ illustrated in FIGS. 7 and 8 is 45°.

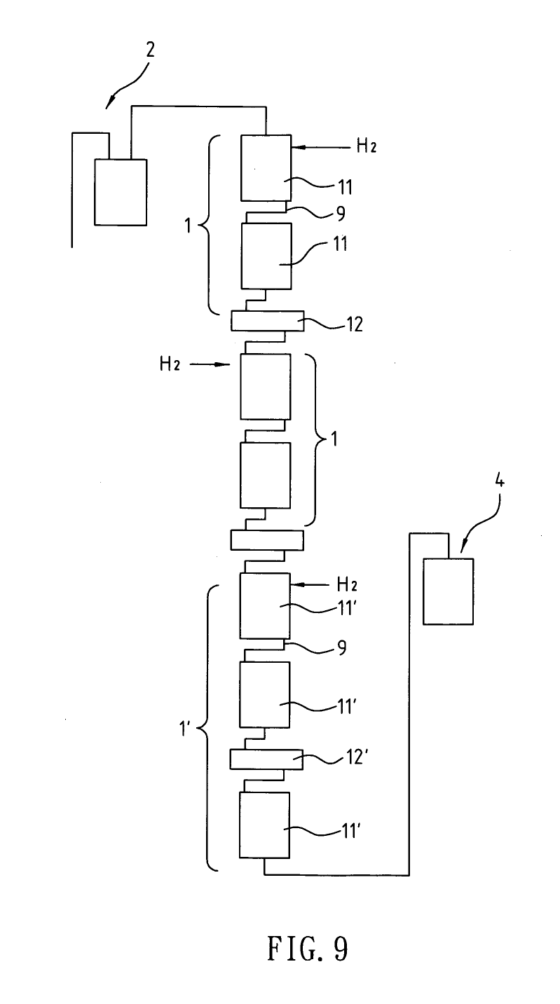

In the first and second embodiments, though each of the hydrogenation reaction units 1 has only one hydrogenation reactor 11, the hydrogenation reaction unit 1 can be composed of two or more hydrogenation reactors 11. As shown in FIG. 9, the second embodiment of the apparatus for hydrogenation includes three hydrogenation reaction units 1, 1′. Compared to the first embodiment, each of hydrogenation reaction unit 1, 1′ of this embodiment has one more hydrogenation reactor 11, 11′, and the hydrogenation reaction units 1, 1′ comprises third guiding parts 9 connecting the hydrogenation reactors 11 or 11′ there between.

In the present invention, the method for continuous hydrogenation of the conjugated diene polymer comprises steps of:

(a) providing an above-mentioned apparatus for hydrogenation;

(b) feeding a conjugated diene polymer, a catalyst composition and a hydrogen into the hydrogenation reactor 11, 11′, and mixing them in a non-mechanical mixing mode for hydrogenation to obtain a hydrogenated mixture; and

(c) introducing the hydrogenated mixture into the heat exchanger 12, 12′ to remove a part of heat.

According to the steps (a), (b) and (c), a hydrogenated conjugated diene polymer is obtained.

In the step (a) of the method of the present invention, the hydrogenation reactor has an average temperature ranges between 30° C. and 150° C. and a pressure ranges between 1 kg/cm² and 30 kg/cm².

In the step (a), the apparatus for hydrogenation further includes a mixing unit 2, and the conjugated diene polymer and the catalyst composition are fed into the mixing unit 2 for mixing and then introduced into the hydrogenation reactor 11 to mix with the hydrogen.

In the first embodiment of the present invention (as shown in FIG. 1), the last hydrogenation reaction unit comprises two hydrogenation reactors 11′ respectively and the heat exchanger 12′ is connected there between. Therefore in the step (c), the hydrogenated mixture is further delivered from the heat exchanger 12′ to another hydrogenation reactor 11′ for hydrogenation.

The following Examples will be used to explain the present invention in detail. However, scope of the present invention should not be limited by the Examples and the above preferred embodiments, and referred to what is claimed.

The analyses and evaluation of physical properties for polymers of the present invention were carried out according to the following methods:

1. Hydrogenation conversion of the hydrogenated conjugated diene polymer was measured with infrared absorption spectrum (IR). Hydrogenation conversion=100%−(residual content of double bonds after hydrogenation/the original content of double bonds before hydrogenation)×100%, double bonds including structure of cis,vinyl and trans.

2. Solid content (wt. %) of the conjugated diene polymer solution=weight of the conjugated diene polymer/(weight of the conjugated diene polymer+weight of the solvent)×100%.

In Examples of the present invention, the conjugated diene polymer comprises:

(1) Conjugated diene polymer SBS-1: linear styrene-butadiene-styrene block copolymer (SBS block copolymer), content of styrene=29 wt. %, content of vinyl structure=45 wt. %, number average molecular weight=105,000.

(2) Conjugated diene polymer SBS-2: linear styrene-butadiene-styrene block copolymer (SBS block copolymer), content of styrene=29 wt. %, content of vinyl structure=43 wt. %, number average molecular weight=90,000.

### Example 1

### Hydrogenating the Conjugated Diene Polymer by the Continuous Process

The conjugated diene polymer SBS-1 (3 kg/hr, based on the weight of the dry polymer), Cp₂TiCl₂ (feeding rate 0.246 g/hr or 0.71 mmol/hr), the polymethylhydrosiloxane (feeding rate 1.05 g/hr), n-butyl lithium (feeding rate 0.57 g/hr) and hexane are fed into the mixing tank 21 as shown in FIG. 1, and are stirred and mixed to form a conjugated diene polymer solution (solid content 15 wt. %). The solution was then continuously introduced into the apparatus for hydrogenation as shown in FIG. 1. The apparatus has six hydrogenation reactors which are abbreviated as A, B, C, D, E and F from upstream to downstream. A plurality of packing 5, as shown in FIG. 3, are placed in each of the hydrogenation reactors of the apparatus for hydrogenation. Meanwhile, the hydrogen is introduced into the hydrogenation reactors A, C and E, and the pressure of the hydrogen at the inlet of each hydrogenation reactor is controlled at about 9 kg/cm². The hydrogenation heat can be removed by controlling water temperature of the jackets of the hydrogenation reactors and the heat exchangers 12, 12′. For the hydrogenation reactors A, B, C, D, E and F, the hydrogenation average temperatures are 76.6° C., 76.3° C., 78.2° C., 80° C., 82.6° C. and 83.1° C., respectively. The retention time of the reaction medium in the apparatus for hydrogenation was about 42 minutes and then collected in the collecting unit (storage tank) to obtain a hydrogenated conjugated diene polymer with a hydrogenation conversion of 97%.

### Examples 2˜4

Procedures of Example 1 are repeated, but dosages and types of conjugated diene polymer SBS-1 or SBS-2, Cp₂TiCl₂, polymethylhydrosiloxane and n-butyl lithium and operation conditions are changed according to Table 1. Hydrogenation conversion of the hydrogenated conjugated diene polymers are listed in Table 1.

The apparatus for continuous hydrogenation of the conjugated diene polymer of the present invention, flowing velocity of the polymer in the hydrogenation reactors 11, 11′ can be buffered by the packing 5 and thus hydrogenation time is increased. Therefore, the polymer can contact well enough with the hydrogen and the catalyst composition and high hydrogenation conversion are obtained. In addition, life of the catalyst composition can be prolonged at a high temperature during hydrogenation because heat was removed by the heat exchanger. Moreover, higher productivity of the hydrogenation conjugated diene polymer is increased by continuous process for hydrogenation and objects of the present invention are achieved.

TABLE 1

| Examples | | 1 | 2 | 3 | 4 |
|---|---|---|---|---|---|
| Conjugated diene polymer | | SBS-1 | SBS-1 | SBS-1 | SBS-2 |
| Feeding | Conjugated diene | 3 | 3 | 3 | 3 |
| rate of the | polymer (dry | | | | |
| mixing | weight) (kg/hr) | | | | |
| tank | PMHS (g/hr) | 1.05 | 0.99 | 0.90 | 1.32 |
| | Cp₂TiCl₂ (g/hr) | 0.246 | 0.279 | 0.195 | 0.249 |
| | NBL (g/hr) | 0.57 | 0.57 | 0.57 | 0.75 |

| Solid content of the polymer | | 15 | 1 | 20 | 20 |
|---|---|---|---|---|---|
| solution (wt. %) | | | | | |
| Pressure of the hydrogen at the | | 9 | 7 | 7 | 7 |
| inlet of each hydrogenation | | | | | |
| reactor (Kg/cm²) | | | | | |
| Average temperature of | A | 76.6 | 79.2 | 78.2 | 78.5 |
| each hydrogenation | B | 76.3 | 80.0 | 81.0 | 79.2 |
| reactor (° C.) | C | 78.2 | 80.1 | 78.1 | 79.7 |
| | D | 80 | 81 | 80.2 | 85.2 |
| | E | 82.6 | 82.4 | 80.5 | 80.2 |
| | F | 83.1 | 80.3 | 80.2 | 80.3 |

| | | | | |
|---|---|---|---|---|
| Hydrogenation conversion (%) | 97 | 96 | 96 | 96 |

Cp₂TiCl₂: bis(cyclopentadienyl) titanium dichloride
PMHS: polymethylhydrosiloxane
NBL: n-butyl lithium

What is claimed is:

1. An apparatus for continuous hydrogenation of a conjugated diene polymer, comprising at least one hydrogenation reaction unit,
wherein each of the hydrogenation reaction unit comprising at least one hydrogenation reactor which has an outlet,
wherein the conjugated diene polymer, a catalyst composition and a hydrogen are mixed in the hydrogenation reactor by a non-mechanical mixing mode; and at least one heat exchanger being connected to the outlet of at least one of the hydrogenation reactor,
wherein the hydrogenation reactor defines a chamber and at least one packing disposed in the chamber,
wherein said packing comprising at least one corrugated plate with a plurality of chutes formed between adjacent two peaks of the corrugated plate,
wherein the chutes are slanted and have an angle ranging between 15 degrees and 65 degrees to the horizon, and
wherein said packing comprises a plurality of corrugated plates, and the alignments of the chutes are crossed for every two adjacent plates.

2. The apparatus of claim 1, which comprises at least two hydrogenation reaction units arranged in series or parallel.

3. The apparatus of claim 1, wherein the hydrogenation reactor further comprises a feeding hole, a distributing element near the feeding hole and at least one gas inlet.

4. The apparatus of claim 1, further comprises a mixing unit prior to and connected to the hydrogenation reaction unit, wherein the mixing unit comprises a mixing tank for contacting the conjugated diene polymer with the catalyst composition.

5. An apparatus for continuous hydrogenation of a conjugated diene polymer, comprising at least one hydrogenation reaction unit,
wherein each of the hydrogenation reaction unit comprising at least one hydrogenation reactor which has an outlet,
wherein the conjugated diene polymer, a catalyst composition and a hydrogen are mixed in the hydrogenation reactor by a non-mechanical mixing mode; and at least one heat exchanger being connected to the outlet of at least one of the hydrogenation reactor,
wherein the hydrogenation reactor defines a chamber and at least one packing disposed in the chamber,
wherein said packing comprising at least one corrugated plate with a plurality of chutes formed between adjacent two peaks of the corrugated plate,
wherein the chutes are slanted and have an angle ranging between 15 degrees and 65 degrees to the horizon, said horizon is a plane perpendicular to the corrugated plate, and
wherein said packing comprises a plurality of corrugated plates, and the alignments of the chutes are crossed for every two adjacent plates.

6. The apparatus of claim 5, which comprises at least two hydrogenation reaction units arranged in series or parallel.

7. The apparatus of claim 5, wherein the hydrogenation reactor further comprises a feeding hole, a distributing element near the feeding hole and at least one gas inlet.

8. The apparatus of claim 5, further comprises a mixing unit prior to and connected to the hydrogenation reaction unit, wherein the mixing unit comprises a mixing tank for contacting the conjugated diene polymer with the catalyst composition.
